(19) United States
(12) Patent Application Publication
(10) Pub. No.: US 2005/0004788 A1
(43) Pub. Date: Jan. 6, 2005

(54) Multi-level confidence measures for task modeling and its application to task-oriented multi-modal dialog management

(76) Inventors: Hang Shun Raymond Lee, Anzac Parade Maroubra (AU); Ronnie Taib, Marseille (FR)

Correspondence Address: MOTOROLA, INC., 1303 EAST ALGONQUIN ROAD, IL01/3RD, SCHAUMBURG, IL, 60196, US

(21) Appl. No.: 10/613,790

(22) Filed: Jul. 3, 2003

(51) Int. Cl. G06F 9/45

(52) U.S. Cl. 703/22

(57) ABSTRACT

A method and system (102) is provided for a multi-modal task-oriented dialog management implemented on a computer-based system. The system (102) maximizes the probability of successful task completion after a task is requested (302). Every task is associated with a task model comprising recipes, acts, parameters and modalities. Confidence measures are calculated at various levels for each task. The confidence measures represent the probability of success of the action depending on the user preferences. The most suitable recipe, act, parameter and modality are selected at runtime using the provided confidence measures (304) to maximize the probability of task completion. After each act, confidence measures are modified (312) depending on the user response, and the next suitable act is accordingly selected. Optionally, a post evaluation module (PEM) is provided for monitoring the user response and modifying the formulation for the confidence measures calculation.

### FIELD OF THE INVENTION

The present invention relates to the field of dialog management systems. More specifically, the present invention provides a method and system for facilitating task completion using a task-oriented, multi-modal dialog management system.

### BACKGROUND OF THE INVENTION

The last couple of decades have seen an increase in the complexity of software applications. This has predominantly happened in order to provide more automation and better functionalities to the user. The improvements in processor speed, hardware architecture and network connectivity have also facilitated this process. With increasing complexity of the applications, the problem of interfacing between the user and the applications has also become complex.

A user interface acts as an interface between the user and various software applications. User interfaces typically use multiple modalities for input/output to the user. A multi-modal user interface system is a user interface system that uses various channels of communication like keyboards and speech recognition/synthesis systems to exchange information between the user and the application. The use of multi-modal user interfaces gives the user/application a flexibility to choose between various modes depending on the type of information to be exchanged.

User interfaces play an important role in the successful completion of a task. The user interfaces contain a dialog manager that employs a task-oriented dialog manager for completion of a task. The dialog manager is task-oriented in that it consists of a task model of the underlying application tasks. A task model for a task consists of multiple recipes, the recipe being a method of performing the task. For example, a task may be to retrieve a song file from a database. There may be multiple recipes to perform this task. Various combinations of title, artist, genre, release data and file format may be used to search the database; and each combination would constitute a different recipe.

In order to complete the task successfully, the dialog manager has to decide on: (1) how the task needs to be achieved; (2) the next action to be performed to progress the task; (3) the information to be exchanged with the user; and (4) the modality to be used for the information exchange between the user and the application. All the above decisions are to be taken at runtime depending on the user preferences and other issues.

One of the main issues faced by the user interface system for a successful completion of a task is to handle variations in the accuracies and availabilities of the modalities and other relevant resources required by the task. The accuracy problem refers to the scenarios where the interface system is not able to receive the user input accurately. Even if the input is received accurately, the interface system may not be able to interpret the input causing interpretation problems. For example, in a speech recognition system, the system may not be able to translate the received speech into text format correctly. Other example of accuracy problem is mistyping with a keyboard or keypad input by the user. Conversely, the user may not be able to interpret the output in the form of a synthesized speech. Interpretation problems may also arise from a text or graphics output that is not legible because of low contrast (due to strong external light) and small/complex text font.

Other relevant resources required by the task refer to the resources like network connections and physical objects relevant to the task domain. An example of a task requiring network connection is a task that requires accessing some information from a remote server. An example of a task requiring physical objects for the task completion is a task in a transport domain that requires a truck as a resource.

Another related issue faced by the user interface systems is to select a recipe to maximize the probability of successful completion of the task. Typically during runtime, the user interface system has to select an appropriate recipe based on user response for completing a task. However, existing user interface systems do not have any technique for deciding what recipe to use in order to maximize the probability of successful task completion.

In the light of the prior art, there exists a need for a method and system for automatically selecting an appropriate recipe for maximizing the probability of successful task completion. In addition, there exists a need for providing robustness of a dialog manager, so as to handle variations in accuracies and availabilities of the modalities and other relevant resources.

### SUMMARY OF THE INVENTION

The present invention is directed towards a method and system for providing a task-oriented multi-modal dialog manager for maximizing the probability of a task completion.

The system comprises a modality resource monitor (MRM), a dialog manager, a confidence measure extractor (CME) and a task modeler. The MRM monitors the availability and performance of all the modalities. The task modeler stores task models for each task that can be performed by the system. The CME provides confidence measures to the dialog manager using the task model as provided by the task modeler and the modality confidence measures as provided by the MRM. The dialog manager controls the dialog interaction with the user.

A task model is typically decomposed into multiple levels of abstraction. A task model for a task comprises at least one recipe for completing the task and the associated acts, parameters and modalities.

After receiving a request for a task, confidence measures are calculated by the CME at runtime for each of the recipes, acts and parameters associated with the task. A confidence measure corresponds to a probability score that the concerned task model component can be completed successfully. Confidence measures at a higher level in the task model are calculated based on the lower level confidence measures and other knowledge sources available for the current level.

A suitable recipe with the highest confidence measure is selected for maximizing the probability of task completion. Similarly, a suitable act and suitable parameters are also selected for the suitable recipe. The suitable act is executed after that.

Upon receiving the user response to the suitable act, the confidence measures for the suitable recipe, the suitable act and suitable parameters are updated based upon the actual confidence measure as reported by the modality. The method again jumps back to the step of selection of the suitable recipe, the suitable act and the suitable parameters. These steps are repeated until the task is successfully completed. In this way, the invention provides for a dynamic selection of a suitable recipe and a suitable act after the execution of every act.

The system in accordance with the present invention may optionally have a post evaluation mechanism (PEM). PEM monitors the user response to the various acts that are executed and modifies the formulation for the calculation of confidence measures. This helps in continuously improving the system according to the user preferences.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram illustrating an exemplary system that implements a method for multi-modal task-oriented dialog management in accordance with the present invention;

FIG. 2 is a tree structure illustrating an exemplary task model;

FIG. 3 is a flowchart illustrating a method of multi-modal task-oriented dialog management in accordance with the preferred embodiment of the present invention;

FIG. 4 is a flowchart illustrating a method for providing confidence measures;

FIG. 5 is a flowchart illustrating a dialog control method;

FIG. 6 is a table showing a task model for the task of finding an audio file; and

FIG. 7 is a table showing a calculation of confidence measures for Recipe_{—}1 of the task model for finding the audio file.

### DETAILED DESCRIPTION OF PREFERRED EMBODIMENTS OF THE INVENTION

The present invention provides a method and system for task-oriented multi-modal dialog management for maximizing the probability of successful task completion.

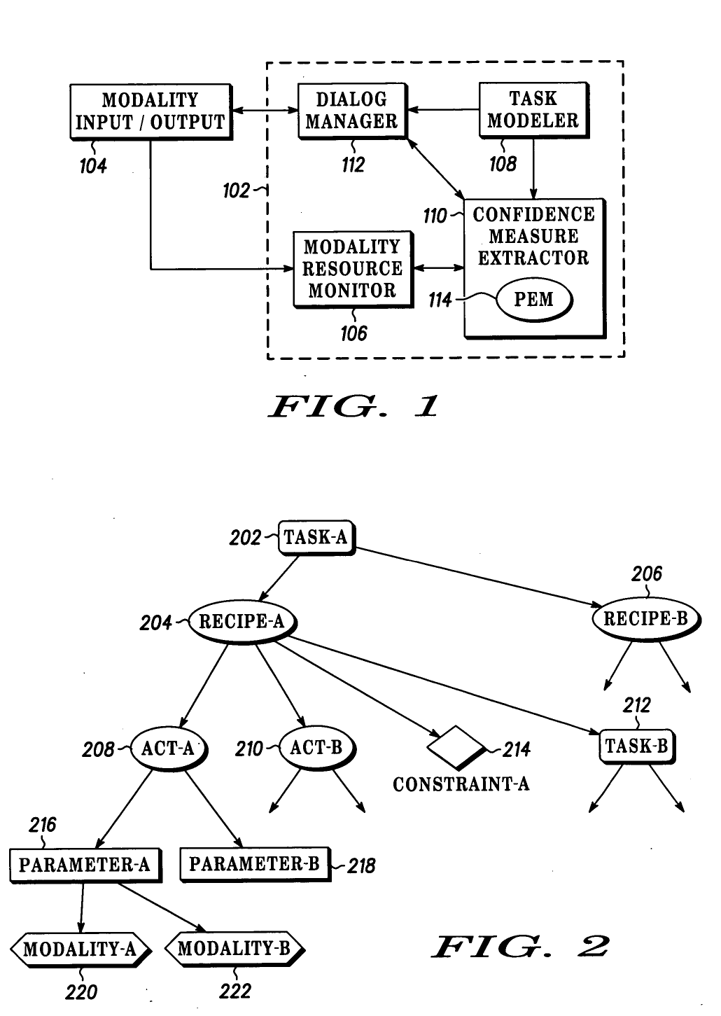

FIG. 1 is a block diagram of an exemplary system that implements a method for dialog management in accordance with the preferred embodiment of the present invention. A computer-based system 102 is connected to at least one modality 104 for user interaction. Computer-based system 102 comprises a modality resource monitor (MRM) 106, a task modeler 108, a confidence measure extractor (CME) 110 and a dialog manager 112. MRM 106 monitors various modalities 104 and provides information to CME 110. Task modeler 108 stores a repository of task models associated with various tasks, and provides the task models to dialog manager 112 and CME 110. CME 110 provides confidence measures for the task models at various abstraction levels, to dialog manager 112. CME 110 may optionally have a post evaluation module (PEM) 114 for modifying the confidence measure formulation according to the user response. Dialog manager 112 has a dialog control method that uses the confidence measures and the task model for dialog management. Hereinafter, each component of the system is explained in detail.

At least one modality 104 is used for receiving input and providing output to a user. Examples of different input modalities that may be used are: a keyboard, a speech recognition system, a mouse, a joystick and a touch-screen. Similarly, examples of various output modalities are: a monitor, a touch-screen, a speech synthesis system and a virtual reality system. It would be apparent to any one skilled in the art that the method disclosed in the present invention can work with any modality.

Computer-based system 102 may be any of the computer-based systems including, but not limited to, a computer, a laptop, a tablet PC, a palm PC, a smartphone, a personal digital assistant (PDA) and various embedded systems.

Task modeler 108 comprises models for all the tasks that an underlying application can perform. A task model for a task comprises multiple recipes for performing the task. Each task is associated with at least one recipe in the task model. The task models are provided by task modeler 108 to dialog manager 112 and CME 110. These task models are supplied by the underlying application. These task models may be provided by the applications in any of the schemes as accepted or decided by the dialog manager. As an example, an application developer may define the task model of the application in a descriptor file using Extensible Markup Language (XML) following the scheme (in Document Type Definitions) defined by the dialog manager. The dialog manager may read the descriptor file and load the application task model descriptor, parse the XML file and generate the internal representation of the task model for its use.

Alternatively, the dialog manager may provide a software library comprising domain independent task modeling classes. The application developer may implement the codes of the task model by using the software library provided by the dialog manager. The codes thus generated are then compiled into the application to be used by the dialog manager.

A recipe is a specific method of performing a task. Each recipe is associated with a set of acts and a set of constraints. An act is a step to be performed in a given recipe. Each recipe consists of one or more acts. The constraints specify the temporal ordering and other bindings, if any, between the various acts associated with the recipe. Each act is in turn associated with a set of parameters that have to be completed, by a user at the modality input/output 104, for the act to be executable. Each parameter is associated with a set of modalities that may be used for inputting/outputting the parameter to the user.

An exemplary task model for a task is illustrated in FIG. 2. A Task-A 202 is associated with a Recipe-A 204 and a Recipe-B 206. Recipe-A 204 in turn is associated with an Act-A 208, an Act-B 210, a Task-B 212 and a Constraint-A 214. Constraint-A 214 involves the temporal relation between Act-A 208, Act-B 210 and Task-B 212. The fact that Task-B 212 is associated with Recipe-A 204 shows the recursive property of the task model. In other words, an act of a recipe may itself consist of a task having its own task model. Act-A 208 is associated with a Parameter-A 216 and a Parameter-B 218 required for completing Act-A 208. Parameter-A 216 is associated with a Modality-A 220 and a Modality-B 222.

An exemplary task model for the task of finding an audio file containing a song is explained hereinafter. Various recipes may be available for this task. A recipe may consist of the acts of specifying the song name, specifying the artist name and searching the database. The act of specifying the song name is associated with a string parameter Song_Name. Similarly, the act of specifying the artist name is associated with a string parameter Artist_Name. The recipe is also associated with a constraint that the act of searching the database would be performed after the other two acts.

MRM 106 provides information about the available input/output modalities. In particular, MRM 106 detects the availability of modalities and obtains accuracies of each available modality. An accuracy of a modality is the ability of the modality to interpret and share the information correctly with a user. MRM 106 comprises a set of resource monitors for all the modalities. The resource monitor for each modality monitors various parameters like availability, accuracy etc. of the modality. For example, if a speech recognition system is connected to computer-based system 102, then a corresponding resource monitor for the speech recognition system will be included in MRM 106. It would be evident to one skilled in the art that any of the standard resource monitors available in the art may be used to form MRM 106. For example, the availability of modalities of mobile devices may be provided by W3C's CC/PP (Composite Capabilities/Preferences Profile) standard. More information about this can be found at Internet URL site: http://www.w3.org/Mobile/CCPP. The accuracy information of a modality is typically provided by the individual modality specific API. For example, the Java Community Process has delivered a specification called Java Speech API (JSAPI) for the monitoring of speech resources.

The accuracies of various modalities are passed on to CME 110 for providing and modifying the confidence measures. CME 110 provides the confidence measures at the various abstraction levels of the task model. A confidence measure represents a probability score for completing the task model level component successfully. CME 110 uses the task model from task modeler 108 and the modality information from MRM 106 to calculate the confidence measures. CME 110 also stores the confidence measures for future use. CME 110 may optionally comprise post evaluation module (PEM) 114 for modifying the formulation for calculating confidence measures according to the user preferences. The method for providing confidence measures is further explained later in the description with reference to FIG. 4.

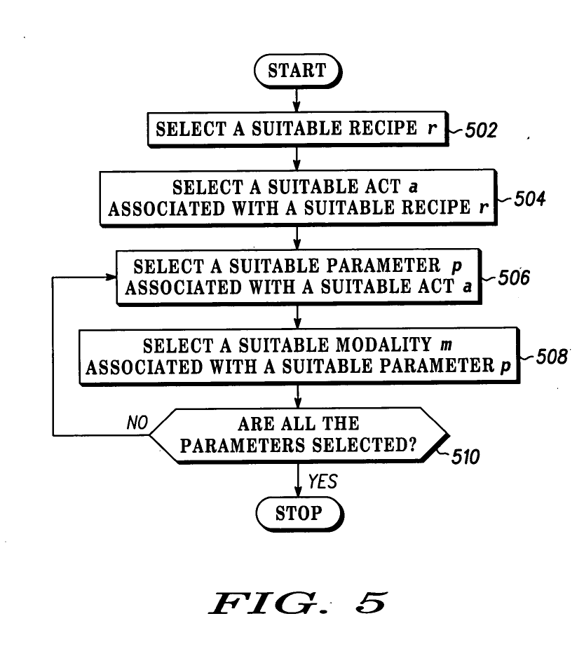

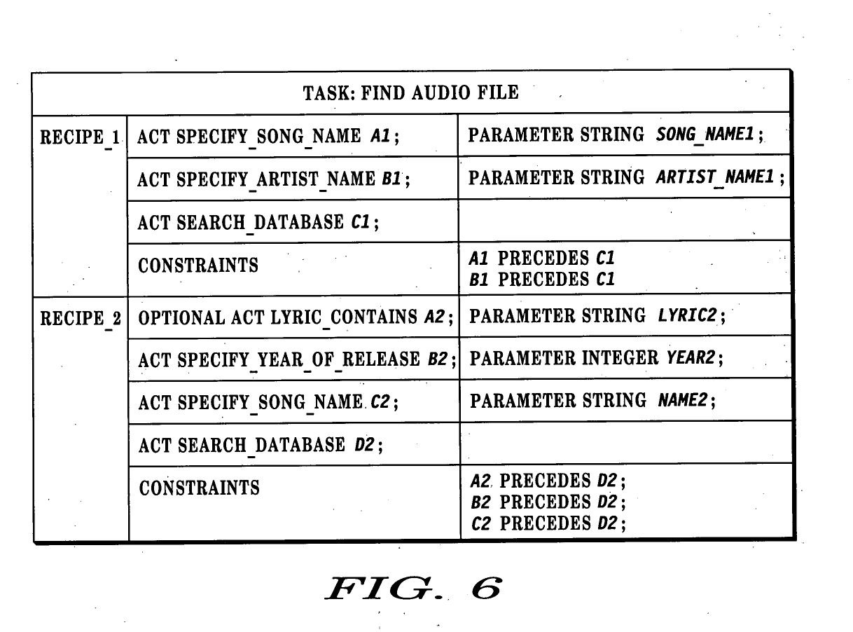

Dialog manager 112 receives the confidence measures from CME 110. The dialog control method in dialog manger 112 uses these confidence measures to maximize the probability of task completion. Dialog manager 112 also generates system commands to execute the task. Dialog manager 112 identifies a suitable act using the confidence measures and the task model received from task modeler 108. This task model is also used by dialog manager 112 for executing the task. The dialog control method is further explained later in the description with reference to FIG. 5.

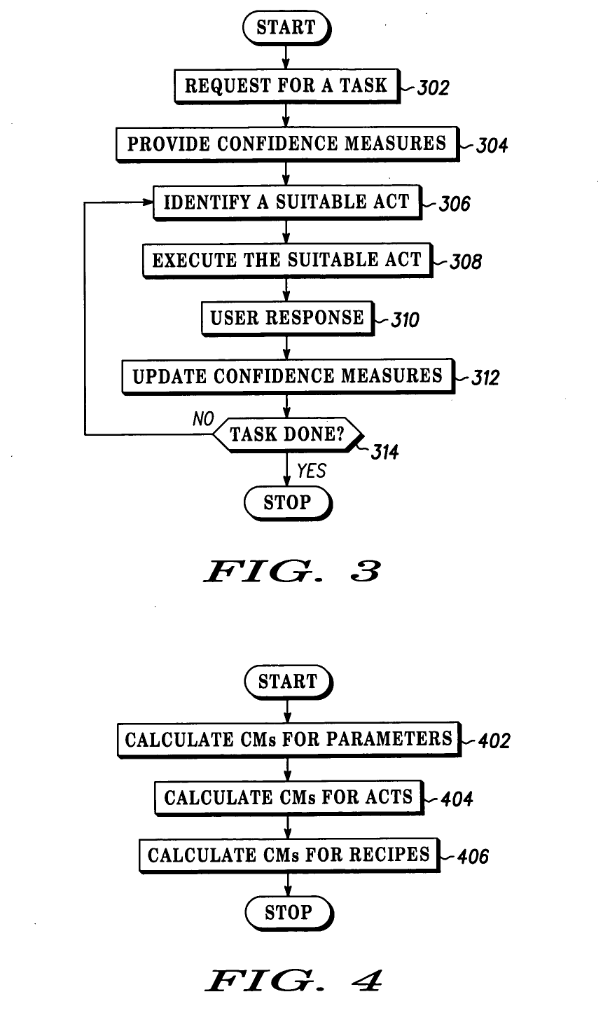

Referring to FIG. 3, there is illustrated a flowchart of a method of multi-modal task-oriented dialog management in accordance with the preferred embodiment of the present invention. A user or an application makes a request for a task at step 302. The request for the task is received by dialog manager 112. The user may request the task using any of the available input modalities 104. The application may request a task in the dialog manager by an event-listener mechanism. In this case, the dialog manager is registered to the application as a listener for task events. A request-task event is generated by the application whenever it desires to request for a task in the dialog.

Upon receiving the request for the task, confidence measures are provided by CME 110 at step 304. Confidence measures for the recipes, the acts and the parameters associated with the task are provided at this step.

After providing the confidence measures at step 304, a suitable act to be executed is identified using the provided confidence measures at step 306. The suitable act is identified by dialog manager 112 for facilitating the completion of the task using the dialog control method.

After the identification of the suitable act, the act is executed by dialog manager 112 at step 308 using the suitable parameters. Dialog manager 112 generates system commands for executing the suitable act.

Dialog manager 112 then waits and receives the user response 310 to the suitable act. The confidence measures are updated based upon the user response at step 312.

At step 314, the state of the task is checked. If the task is completed, then the method is over. If the task is not completed then the next suitable act is identified to facilitate the completion of the task and the subsequent steps are repeated. Hereinafter, the steps as described above are elaborated in detail.

FIG. 4 is a flowchart of the steps involved in calculation of the confidence measures in accordance with the preferred embodiment of the present invention. This method is embodied in CME 110. At step 402, a parameter level confidence measure (PLCM) for each parameter is calculated. Confidence measures for all the parameters present in the task model for the task are calculated. The PLCM can be calculated in various ways. Two exemplary ways are described hereinafter.

If the parameter is not provided by the user until the time of calculation, the PLCM is calculated using two factors: (1) the estimated accuracies of the modalities that may be used to obtain the parameter, and (2) the corresponding estimated probabilities of use of a modality for the parameter. This dependence may be represented as:
PLCM=f({m(p), w(m,p): m,p})
where,
p is a parameter;
m(p) is the estimated accuracy of a modality for input/output of parameter p; and
w(m,p) is the estimated probability of use of modality m for input/output of parameter p.

The estimated accuracies m(p) of the modalities may be obtained from the stored values that are based on the user preferences. In another approach, these accuracies might be initially defined by the user or the modality. In case the accuracies are not available, default values of m(p) may be used.

The probabilities w(m,p) of use of the modality may be obtained from the stored values based on the user preferences. In case, these probabilities are not available, the system allocates equal probability to all the available modalities for the parameter. These probabilities may be application specific, and might be provided by the underlying application. The probabilities may be dynamically modified, based on the actual modality used, in order to adapt the system to the user preferences.

If the parameter has already been provided by the user before the calculation of the PLCM, then the confidence measures as obtained from MRM 106 are directly used to calculate the PLCM.
PLCM=CM(m,p)
where,
CM(m,p) is the confidence measure of a modality m for input/output of parameter p, as provided by modality m.

It would be evident to one skilled in the art that any method for providing confidence measures for an input/output modality may be employed. One such system is disclosed by Ruben San Segundo et. Al. in the publication titled “Confidence Measures for Dialogue Management in the Cu Communication System” published in Proceedings ICSLP 2000, Vol. 2, page no. 1237-1240. Some of the other systems are disclosed in U.S. Pat. No. 5,710,864 titled as “Systems, methods and articles of manufacture for improving recognition confidence in hypothesized keywords” and U.S. Pat. No. 5,710,866 titled as “A system and method for speech recognition using dynamically adjusted confidence measure”. The above references are included in this specification as a short hand method of describing confidence measures.

At step 404, an act level confidence measure (ALCM) for each act from the set of acts associated with all the recipes in the task model is calculated. An ALCM for an act represents the probability of the act being properly specified and executed. It is calculated using the PLCM of each parameter from the set of parameters associated with the act. ALCM is also dependent on some application specific criteria. As an example, consider an act that requires a network connection for its successful completion. Then the application specific criterion for the act is the reliability of a network connection. The application specific criteria and other similar factors are represented by a generic probability of the act being executed successfully. The abovementioned dependence of ALCM may be represented as follows:
ALCM=g(PLCM(p), p(S))
where,
PLCM(p) is the parameter level confidence measure for parameter p from the set of parameters associated with the act; and
p(S) is the generic probability of the act being executed successfully.

At step 406, a recipe level confidence measure (RLCM) for all the recipes from the set of recipes associated with the task is calculated. An RLCM for a recipe is a probability of successful completion of the task by using the recipe. It is calculated using the constraints and the ALCMs of the acts from the set of acts associated with the recipe. The abovementioned dependence may be represented as:
RLCM=h(ALCM(a), C)
where,
ALCM(a) is the act level confidence measure for act a from the set of acts associated with the recipe; and
C is a set of constraints associated with the recipe.

An exemplary manner of including the constraints in the RLCM calculation is described below. Consider a recipe with acts aᵢ where i may vary from 0 to m. The recipe is associated with a set of constraints that define the temporal order of the recipe's acts. The temporal constraints between the acts aᵢ and aⱼ may be defined as parameter Cᵢⱼ where:

$$\begin{matrix}{C}_{ij} = 1 if {a}_{j} can be executed in the recipe after {a}_{i} ; and \\ = 0 if {a}_{j} cannot be executed in the recipe after {a}_{i} .\end{matrix}$$

Similarly, Cⱼᵢ may also be defined.

Then, the confidence measure for all possible act sequences in accordance with the constraints is calculated. The RLCM of the recipe is then defined as the maximum of the confidence measures for all the possible act sequences. Any act sequence that does not satisfy the temporal constraint will have the confidence measure 0. This definition of the RLCM function h may be represented as:
h=max{hₚ(ALCM(aᵢ), Cᵢⱼ, ALCM(aⱼ), Cⱼₖ, . . . ALCM(aₘ))}
where, hₚ is the confidence measure of a specific act sequence.

It will be apparent to one skilled in the art that various other formulations may be employed to include constraints in the recipe calculation. Also, it may be noted that all the methods and formulations illustrated above for the calculation of confidence measures are exemplary. It would therefore be apparent to one skilled in the art that the present invention can work with other formulations.

FIG. 5 is a flowchart for the identification of a suitable act is shown in accordance with the preferred embodiment of the present invention. At step 502, a suitable recipe is selected from the set of recipes associated with the task. The suitable recipe is a recipe with the highest confidence measure from the set of recipes associated with the task. An exception to this selection of the suitable recipe is the scenario where the user has already pre-selected a particular recipe for the task. Then the recipe selected by the user is the suitable recipe.

After the suitable recipe is selected at step 502, a suitable act is selected at step 504. The suitable act is an act with the highest confidence measure from the set of acts associated with the suitable recipe. The selection of the suitable act maximizes the probability of the successful completion of the task in the next dialog turn and hence the progress of the task.

At step 506, a suitable parameter is selected from the set of parameters associated with the suitable act. The suitable parameter is a parameter with the highest confidence measure from the set of parameters associated with the suitable act.

At step 508, a suitable modality is selected for the selected parameter. The suitable modality is a modality with the highest confidence measure from the set of modalities associated with the suitable parameter.

Steps 506 and 508 are repeated until all the parameters from the set of parameters associated with the suitable act are selected at step 510.

Referring back to FIG. 3, at step 312, the updating of the confidence measures is performed in the following manner. Initially, the PLCM associated with each parameter in the set of parameters associated with the suitable act is modified. The modification of PLCM is described hereinafter. The estimated accuracy of the modality used for the parameter is modified using a feedback factor in accordance with the user response. The feedback factor is added/subtracted according to the user response. The feedback factor is an adjustment factor to reflect the confidence measures at various levels depending on the user preferences. After this, the PLCM is recalculated with the modified accuracies of the modalities. The change in the modality accuracy changes the PLCM, as the PLCM is calculated according to the formulation as elaborated in conjunction with the description of FIG. 4.

The ALCM of the suitable act is then modified using the modified PLCM of each parameter from the set of parameters associated with the suitable act using the formulation as elaborated in conjunction with the description of FIG. 4. At next step, the RLCM of the suitable recipe is modified using the modified ALCM of each act from the set of acts associated with the suitable recipe using the formulation as elaborated in conjunction with the description of FIG. 4.

In an alternative embodiment of the present invention, only single level confidence measures may be calculated instead of the multi-level confidence measures. In this case, only RLCM may be calculated directly instead of the multi-level approach.

In another alternative embodiment, the PEM evaluates the user response to assess its relevance for successful task completion. This is performed by assessing whether the act had the expected effect on the user and determining whether the dialog can move forward in the next turn. If the dialog is backtracking, then the system adjusts the confidence measure formulas to decrease the weight of the last recipe, act and the associated parameters. This helps in improved selection of a recipe, act and parameter in the future to maximize the probability of task completion.

For example, consider an act that aims at achieving an informative task. The system in accordance with an embodiment of the present invention decides to display an image instead of using speech synthesis for outputting a text. If the user is satisfied with the output, the user will ask for the information on the next step to be performed. Suppose, the user responds with “I cannot read the details” because the image is too small to be viewed on the available device. Then, the interface system would discard the image output for similar tasks in the future.

An exemplary method of modifying the formulation for the confidence measure calculation according to the user response is described henceforth.

In an approach, the formula for the PLCM may be modified by a feedback factor depending on the user response. If the user response is positive then the formula for the PLCM is increased by the feedback factor. If, on the contrary, the user response is negative, the formula for the PLCM is decreased by the feedback factor. The modified formula may be represented as:
PLCM=f({m(p), w(m,p): m,p})+E_{P}
where, E_{P} is a feedback factor that is added/subtracted based on the user response.

In another approach, the formula for the ALCM may be modified by a feedback factor depending on the user response. If the user response is positive then the formula for the ALCM is increased by the feedback factor. If, on the contrary, the user response is negative, the formula for the ALCM is decreased by the feedback factor. The modified formula may be represented as:
ALCM=g(PLCM(p), p(S))+E_{A}
where, E_{A} is a feedback factor that is added/subtracted based on the user response.

In a different approach, the formula for the RLCM is modified by a feedback factor depending on the user response. The modified formula may be represented as:
RLCM=h(ALCM(a), C)+E_{R}
where, E_{R} is a feedback factor that is added/subtracted based on the user response.

In an alternative embodiment, a machine learning mechanism may be employed to dynamically modify the PLCM, ALCM and RLCM formulas in accordance with the user's preferences, the current application specific preferences and the context specific issues. In this case, the feedback factors E_{P}, E_{A} and E_{R} are dependent on the user preferences, the application specific preferences and the context specific issues. User preferences may be important in the case of people with disability. For example, a hearing impaired person may chose graphical or text outputs over spoken outputs. Context specific issues refer to the effect of time and place of the execution on the choice of a recipe for a task. For instance, a speech synthesis system may not be a good option for output in outdoor locations. Hence, a video monitor would be given preference over the speech synthesis system for presenting the output. Another example of context specific issues are the changing preferences of the user according to the locations (for e.g. cinema, meeting, home etc.).

Though the present invention has been disclosed with the help of a speech recognition/synthesis modality, it would be obvious to one skilled in the art that the present invention may be extended to any modality without deviating from the spirit of the invention.

A single CME in accordance with the present invention may be implemented for a single application or for multiple applications. However, the applications have to provide a task model to the CME in the form defined by the present invention. CME may then operate on the combined task model. For example, the CME in accordance with the present invention may reside on a smartphone with its task model for typical phone operations like dialing and phonebook. The phone may also be connected to a network, which provides extra applications such as media information search. The smartphone then becomes a terminal that provides both typical phone operations and media information search. The CME can thus interact with the user to access either the local or the networked applications. In some cases, it may also be possible that the additional application extends the existing application by providing new recipes to perform the task.

Having described the method and system, an example is presented below that illustrates the use of the present invention. A task domain in which a user interacts with the system to find an audio file in his CD collection is illustrated herein. The system is connected to a speech and graphic/text modality for both receiving input and providing output. The task model is shown in FIG. 6. It consists of two recipes: Recipe_1 and Recipe_2. Each recipe consists of a number of acts that needs to be performed for the recipe (and hence the task) to be completed. For example, Recipe_1 is associated with the acts specify_song_name, specify_artist_name and search_database. Recipe_1 is also associated with the constraints that give the temporal ordering of the acts. Each act is, in turn, associated with a number of parameters, which need to be specified. For example, act specify_song_name is associated with a parameter Song_Name1.

Once the user requests for the task of searching for the audio files, CME 110 computes confidence measures for both the recipes. The confidence measures are calculated as follows.

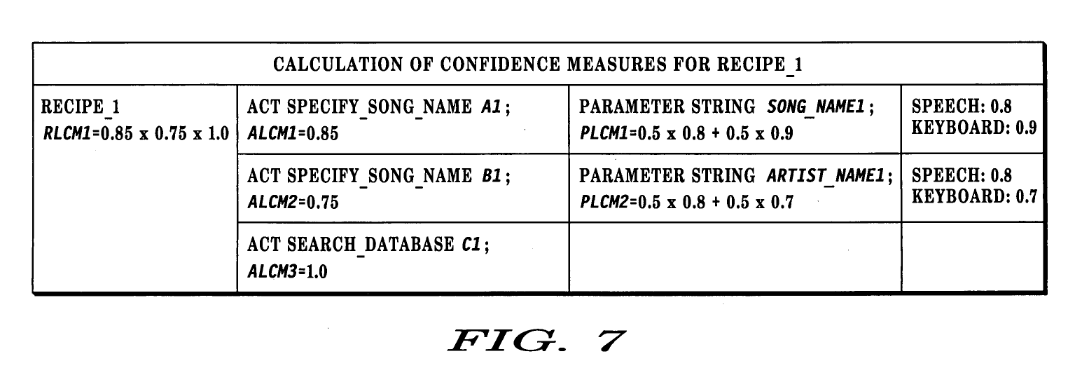

FIG. 7 illustrates the multi-level confidence measures are illustrated for Recipe_1. The accuracies of the various modalities for every parameter are obtained from the stored values. These accuracies might also be obtained from the modalities themselves. For example, the modality accuracies for the parameter Song_Name1 are 0.8 and 0.9 for speech recognition system and keyboard respectively. These accuracies and the probabilities of use of each modality for the parameter are used to calculate PLCM for each of the parameters. Two modalities are available for each parameter in the present example. Hence, a probability of 0.5 has been assigned to each modality. The function used for the calculation of the PLCM is:
PLCM=Σ{p(m)×w(m,p)}

Hence, PLCM is calculated as 0.5*0.8+0.5*0.9=0.85.

The ALCM for an act has been defined as the multiplication of the PLCMs of the parameters associated with the act. All the ALCMs are calculated using this formulation. Similarly, RLCM for a recipe has been defined to be the multiplication of the ALCMs of the acts associated with the recipe. All the functions used for the calculation of confidence measures are exemplary and are chosen to simplify the formulation.

Similarly, the confidence measures for Recipe_2 are calculated. A suitable recipe is then selected based on these confidence measures. For exemplary purposes, consider that the RLCM for Recipe_2 is 0.6. Hence, Recipe_1 with RLCM of 0.68 is selected over Recipe_2 as the suitable recipe. Considering the constraints and the ALCMs, act specify_song_name is selected as the suitable act to be executed. As this act has only one parameter, it is selected as the suitable parameter. For exemplary purposes, if the user selects to use speech mode for this parameter, following would be the application-user interaction:
Recipe_1 Act: Please specify the song name.
User response_1: “Love Song”

The confidence measure for this interaction as provided by the modality is assumed 0.5 for exemplary purposes. The PLCM for the parameter Song_Name1 and the ALCM for the act specify_song_name are modified using revised (new) confidence measure values for the speech modality, these revised confidence measure values of the formula PLCM=CM(m,p) described above. The RLCM for Recipe_1 is also modified using the modified ALCM. The modified RLCM for Recipe_1 is 0.165. Hence, the system selects Recipe_2 with RLCM of 0.6 as the suitable recipe to maximize the probability of task completion. This dynamic selection of recipes according to the present invention helps in maximizing the probability of successful task completion. The act with the highest ALCM and satisfying all the constraints is selected as the suitable act. For exemplary purposes, it is assumed that the act specify_year_of_release is the suitable act. Following is the application-user interaction:
Recipe_2 Act: What is the year of release?
User response_2: “2002”

The complete procedure of updation of confidence measures is again repeated. For exemplary purposes, it is assumed that Recipe_2 still has a higher RLCM than Recipe_1. Further interaction would be as follows:
Recipe_2 Act: To help me find the file, key in a few words of the lyric if you could.
User response_3: “the real world”

After this, the act of searching the database is performed and the results are returned to the user.

The present invention may be employed in a dialog manager for various high-end networked devices that provide a multitude of applications and services to the connected devices. The connected devices may be various mobile devices like smartphones, laptops and personal digital assistants (PDAs).

For example, a database providing media content and search facilities to various devices connected over a network may use this invention. In general, the information browsed and searched can be any media information such as image, sound and video clips. A user might be searching for the media information by interacting with a server over a network (e.g. GPRS or 3G) using a mobile device like a smartphone. These data searches are typically carried out using descriptors associated with the media information. For example, a photo image can be annotated with descriptions of its size, date, people, place etc. The interaction in such cases involve multiple dialog turns between the user and the system in which the user provides or modifies his search criteria based on the current state of the dialog and search results. The invention is used here to manage the interaction, by dynamically finding and applying the suitable recipe depending on the particular smartphone's modality capability.

Another example is a movie-finder application where a user can search for a movie to go to, and reserves tickets online using a wireless device (e.g. mobile handset). In this case, the user can browse and search a movie using various criteria such as by locations (movie theatre, suburb), by genre or by show times depending on the user preference and the device's modality availability. Depending on the output capability of the device and the context, the application will render its information differently. For example, a seating plan of the movie theatre can be shown on a color handset with sufficient graphics resolution, while a simple form is shown on a monochrome device. The dialog interaction is also affected by the context in which the dialog takes place, e.g. location of the user, time of day.

The present invention may be embodied on any computer-based system. Typical examples of a computer system includes a general-purpose computer, a programmed microprocessor, a micro-controller, a peripheral integrated circuit element, and other devices or arrangements of devices that are capable of implementing the steps that constitute the method of the present invention.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. A method of facilitating completion of a task by a computer-based system, the task being requested by a user or an application on the computer-based system, the task being associated with a set of recipes, each of the recipes being associated with a set of acts and a set of constraints, the recipe defining the manner of execution of acts for the completion of the task, each of the acts being associated with a set of parameters, each of the parameters being associated with a set of modalities, the modality being a communication channel between the user and the computer-based system, the method comprising:
providing confidence measures for the recipes, the acts and the parameters associated with the task;
identifying a suitable act to be executed using the provided confidence measures, the suitable act being identified for facilitating the completion of the task;
executing the suitable act;
receiving a user response to the executed suitable act;
updating the confidence measures in accordance with the user response; and
repeating the identifying to updating steps until the task is completed.

2. The method as recited in claim 1 wherein providing the confidence measures for the recipes, the acts and the parameters comprises:
calculating a confidence measure for each parameter;
calculating a confidence measure for each act using the confidence measures for the set of parameters associated with the act; and
calculating a confidence measure for each recipe using the confidence measures for the set of acts associated with the recipe.

3. The method as recited in claim 2 wherein the calculation of confidence measure for each parameter comprises:
estimating accuracies of the set of modalities associated with the parameter;
estimating probabilities of the usage of the set of modalities associated with the parameter; and
calculating the confidence measure for the parameter using the estimated accuracies and the estimated probabilities.

4. The method as recited in claim 2 wherein confidence measure for each act is calculated using the confidence measures for the set of parameters associated with the act and the probability of the act being executed successfully.

5. The method as recited in claim 2 wherein the confidence measure for each recipe is calculated using the confidence measures for the set of acts associated with the recipe and the set of constraints associated with the recipe.

6. The method as recited in claim 1 wherein the confidence measures are calculated using one or more from a group consisting of user preferences, application specific preferences and context specific issues.

7. The method as recited in claim 1 wherein identifying the suitable act comprises:
selecting a suitable recipe, the suitable recipe being a recipe with the highest confidence measure, the suitable recipe being selected from the set of recipes associated with the task;
selecting the suitable act, the suitable act being an act with the highest confidence measure, the suitable act being selected from the set of acts associated with the suitable recipe;
selecting a suitable parameter, the suitable parameter being a parameter with the highest confidence measure, the suitable parameter being selected from the set of parameters associated with the suitable act;
selecting a suitable modality, the suitable modality being a modality with the highest confidence measure, the suitable modality being selected from the set of modalities associated with the suitable parameter; and
repeating the sub-steps of selecting a suitable parameter to selecting a suitable modality until all the parameters within the set of parameters associated with the suitable act are selected.

8. The method as recited in claim 1 wherein updating the confidence measures comprises:
modifying the confidence measures for the set of parameters associated with the suitable act based on the observed user response;
modifying the confidence measure for the suitable act using the modified confidence measures for the set of parameters associated with the suitable act; and
modifying the confidence measure for the recipe associated with the suitable act using the modified confidence measure for the suitable act.

9. The method as recited in claim 1 further comprising storing the updated confidence measures for future use.

10. The method as recited in claim 1 further comprising:
evaluating the user response to the executed act; and
modifying a formulation for the confidence measure calculation based on the evaluation, the formulation being the formulas for the calculation of the confidence measures.

11. The method as recited in claim 10 wherein modifying the formulation for the confidence measure calculation is performed using a machine learning mechanism.

12. A computer program product for use with a computer, the computer program product comprising a computer usable medium having a computer readable program code embodied therein for facilitating completion of a task, the task being requested by a user or an application on the computer-based system, the task being associated with a set of recipes, each of the recipes being associated with a set of acts and a set of constraints, the recipe defining the manner of execution of acts for the completion of the task, each of the acts being associated with a set of parameters, each of the parameters being associated with a set of modalities, the modality being a communication channel between the user and the computer-based system, the method comprising:
providing confidence measures for the recipes, acts and parameters associated with the task;
identifying a suitable act to be executed using the provided confidence measures, the suitable act being identified for facilitating the completion of the task;
executing the suitable act;
receiving user response to the executed suitable act;
updating the confidence measures in accordance with the user response; and
repeating the identifying to updating steps steps until the task is completed.

13. The computer program product as recited in claim 12 wherein the computer program code performing the step of providing the confidence measures for the recipes, the acts and the parameters comprises a computer program code for performing the sub-steps of:
calculating a confidence measure for each parameter;
calculating a confidence measure for each act using the confidence measures for the set of parameters associated with the act; and
calculating a confidence measure for each recipe using the confidence measures for the set of acts associated with the recipe.

14. The computer program product as recited in claim 12 wherein the computer program code performing the step of identifying the suitable act comprises a computer program code for performing the sub-steps of:
selecting a suitable recipe, the suitable recipe being a recipe with the highest confidence measure, the suitable recipe being selected from the set of recipes associated with the task;
selecting the suitable act, the suitable act being an act with the highest confidence measure, the suitable act being selected from the set of acts associated with the suitable recipe;
selecting a suitable parameter, the suitable parameter being a parameter with the highest confidence measure, the suitable parameter being selected from the set of parameters associated with the suitable act;
selecting a suitable modality, the suitable modality being a modality with the highest confidence measure, the suitable modality being selected from the set of modalities associated with the suitable parameter; and
repeating the sub-steps of selecting a suitable paremeter to selecting a suitable modality until all the parameters within the set of parameters associated with the suitable act are selected.

15. The computer program product as recited in claim 12 wherein the computer program code performing the step of updating the confidence measures comprises a computer program code for performing the sub-steps of:
modifying the confidence measures for the set of parameters associated with the suitable act based on the observed user response;
modifying the confidence measure for the suitable act using the modified confidence measures for the set of parameters associated with the suitable act; and
modifying the confidence measure for the recipe associated with the suitable act using the modified confidence measure for the suitable act.

16. A system suitable for facilitating completion of a task, the task being associated with a set of recipes, each of the recipes being associated with a set of acts and a set of constraints, each of the acts being associated with a set of parameters, each of the parameters being associated with a set of modalities the system being connected to at least one modality for user interaction, the system comprising:
a modality resource monitor for monitoring the various modalities;
a task modeler comprising models for all the tasks, the model for a task comprising the recipes, the acts, the parameters, the modalities and the associations;
a confidence measure extractor connected to the modality resource monitor and the task modeler, the confidence measure extractor providing confidence measures for all the recipes; and
a dialog manager connected to the confidence measure extractor and the task modeler, the dialog manager selecting a suitable act using the confidence measures for facilitating the completion of the task, the suitable act being an act with the highest confidence measure.

17. The system as recited in claim 16 wherein the modalities comprise one or more from the group consisting of a keyboard, a speech recognition system, a mouse, a joystick, a monitor and a touch-screen.

18. The system as recited in claim 16 wherein the confidence measure extractor comprises a post evaluation module for modifying and storing a formulation for the confidence measure calculation based on the user responses.

19. The system as recited in claim 18 wherein the post evaluation module employs a machine learning mechanism that modifies the formulation for the confidence measure calculation using one or more from a group consisting of user preferences, application specific preferences and context specific issues.

20. A method of facilitating completion of a task by a computer-based system, the task being requested by a user or an application on the computer-based system, the task being associated with a set of recipes, each of the recipes being associated with a set of acts and a set of constraints, the recipe defining the manner of execution of acts for the completion of the task, each of the acts being associated with a set of parameters, each of the parameters being associated with a set of modalities, the modality being a communication channel between the user and the computer-based system, the method comprising:
a. providing confidence measures for the recipes, acts and parameters associated with the task;
b. selecting a suitable recipe, the suitable recipe being a recipe with the highest confidence measure, the suitable recipe being selected from the set of recipes associated with the task;
c. selecting the suitable act, the suitable act being an act with the highest confidence measure, the suitable act being selected from the set of acts associated with the suitable recipe;
d. selecting a suitable parameter, the suitable parameter being a parameter with the highest confidence measure, the suitable parameter being selected from the set of parameters associated with the suitable act;
e. selecting a suitable modality, the suitable modality being a modality with the highest confidence measure, the suitable modality being selected from the set of modalities associated with the suitable parameter; and
f. repeating the sub-steps d-e until all the parameters within the set of parameters associated with the suitable act are selected.
g. executing the suitable act;
h. receiving user response to the executed suitable act;
i. updating the confidence measures in accordance with the user response; and
j. repeating the steps b-i until the task is completed.
